(19) United States
(12) Patent Application Publication
(10) Pub. No.: US 2012/0174092 A1
(43) Pub. Date: Jul. 5, 2012

(54) INTEGRATED COMMERCIAL INFRASTRUCTURE AND BUSINESS APPLICATION PLATFORM

(76) Inventors: Wolfgang Faisst, Ettlingen (DE); Stefan Wenzel, Heidelberg (DE); Thorsten Liebermann, Bensheim (DE)

(21) Appl. No.: 12/980,603

(22) Filed: Dec. 29, 2010

(51) Int. Cl. G06F 9/445

(52) U.S. Cl. 717/174

(57) ABSTRACT

A system may include receipt, from a user, of a request to determine a candidate business application, access of a business application platform providing business services to the user in order to determine a business configuration of the business application platform, and determination of a first business application not installed in the business application platform based on the determined business configuration.

### FIELD

Some embodiments relate to business applications within a business application platform. More specifically, some embodiments relate to the addition of new business applications to a business application platform.

### BACKGROUND

Enterprise computing systems are commonly used to provide business services to business users. An enterprise computing system may provide one or more of customer relationship management, human resource management, supply chain management, accounting, or other functions to business users. The term “business application platform” will be used herein to encompass all types of computing systems for providing business services.

A business application platform may include one or more data sources, such as a data warehouse, a business application layer, and a user interface (UI) layer. The data sources may include raw business data in any format, the business application layer may provide functions for accessing and manipulating the data, and the UI layer may provide presentation of visual output to a user, and may also offer mechanisms for the user to interact with business applications of the business application layer.

A conventional business application platform may be hosted by a business in which it is used, or by another party. Examples of the latter scenario include business application platforms hosted “in the cloud” or, more specifically, business application platforms providing software as-a-service (e.g., Web Services).

A business may desire to add business applications to its business application platform in order to acquire increased or improved functionality. Such additions are technically difficult in the case of on-site business application platforms. Cloud-based business application platforms attempt to address this difficulty by offering browser-based interfaces for selecting and purchasing additional business applications. However, in both scenarios, it remains difficult for a business to select and install a business application which is particularly suited to the current configuration of its business process platform. As one reason for this difficulty, the technical issues regarding suitability and compatibility of various business applications are beyond the understanding of many businesses.

### BRIEF DESCRIPTION OF THE DRAWINGS

FIG. 1 is a block diagram of a system according to some embodiments.

FIG. 2 is a flow diagram of a process according to some embodiments.

FIG. 3 is a view of a user interface according to some embodiments.

FIG. 4 is a view of a user interface according to some embodiments.

FIG. 5 is a view of a user interface according to some embodiments.

FIG. 6 is a view of a user interface according to some embodiments.

FIG. 7 is a detailed block diagram of a portion of a system according to some embodiments.

FIG. 8 is a detailed block diagram of a portion of a system according to some embodiments.

FIG. 9 is a block diagram of an apparatus according to some embodiments.

### DETAILED DESCRIPTION

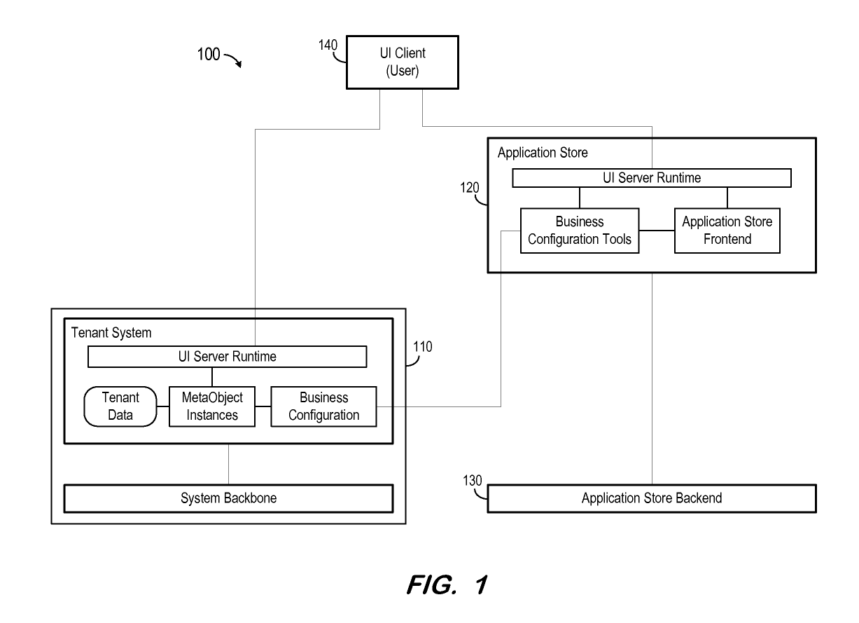

FIG. 1 is a block diagram of system 100 according to some embodiments. System 100 includes business application platform 110, application store 120, application store backend and UI client 140. Generally, business application platform 110 operates to provide business services to UI client 140. Application store 120 may allow UI client 140 to easily purchase additional business applications for use within business application platform 110. Moreover, application store 120 may determine a business configuration of business application platform 110 and may determine, based on the business configuration, a business application not yet installed in business application platform 110.

FIG. 1 represents a logical architecture for describing processes according to some embodiments, and actual implementations may include more or different components arranged in other manners. Moreover, each system described herein may be implemented by any number of devices in communication via any number of other public and/or private networks. Two or more of devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, a Zip® disk, magnetic tape, and solid state Random Access Memory (RAM) or Read Only Memory (ROM) storage units. Embodiments are therefore not limited to any specific combination of hardware and software.

Business application platform 110 may include tenant system 111 and system backbone 112, but embodiments are not limited thereto. To provide economies of scale, tenant system 111 may provide services to a single business, and business application platform 110 may include several tenant systems, each providing services to a respective business. Business application platform 110 includes mechanisms to ensure that a business accesses only the data that the business is authorized to access.

Tenant system 111 includes UI server runtime 113 for interfacing with UI client 140, tenant data 114, metaobject instances 115 and business configuration 116. Tenant system 111 may include many additional components according to some embodiments, some of which are described below.

Tenant data 114 may include any data used to provide business services to the associated business. Such data may include, for example, sales order data, inventory data, shipping data, sales figures, sales projections, etc. Tenant data 114 may also include tenant-independent data which is replicated in other tenant systems of platform 100. Tenant-independent data may alternatively be stored centrally for access by each tenant system.

Tenant data 114 may reside in a physical database or stored in-memory (e.g., in Random Access Memory). The data may comprise a relational database, an in-memory database, a multi-dimensional database, an eXtendable Markup Language (XML) document, and/or any other structured data storage system. The physical tables of data 114 may be distributed among several relational databases, dimensional databases, and/or other data sources.

The structures of and relationships between the physical database tables may be complex, and platform 110 implements metaobject instances 115 to shield developers and end-users from these complexities. A business application may access data and logic through metaobject instances 115 and, in turn, provide data to end-users through user interfaces, reports, etc. Embodiments are not limited thereto.

Metaobjects may include generic models of a business object, a floorplan (i.e., a user interface layout), user interface text, a process component, and a message type, among others. A business object, for example, is a software model representing real-world items used during the transaction of business. An instance of a business object metaobject may comprise a SalesOrder object model or an Organization object model. Instances of these object models, in turn, are referred to as objects and represent specific data (e.g., SalesOrder 4711, ACME corporation). The objects provide a mapping to the underlying tables storing the specific data associated, for example, with a particular sales order.

The metaobject instances (i.e., object models) and the instances thereof (e.g., SalesOrder 4711, ACME corporation) may be embodied in any type of data structure, including but not limited to eXtensible Markup Language files. As in the conventional storage of data, metadata defining the metaobject instances and objects may be stored in database tables and/or any other suitable format.

Business configuration 116 provides technical information regarding the business applications installed in tenant system 111. Business configuration 116 may also include any other information related to the business associated with tenant system 111. Such information may include, but is not limited to, size, location, industry, resource demands, budget, number of users, number of facilities, accounting standards, etc.

Application store 120 may allow a user to purchase business applications for installation into business application platform 110. Application store 120 includes UI server runtime 122 to interface with UI client 140. In this regard, UI client 140 may comprise a Web browser and UI server runtime 122 (as well as UI server runtime 113) may comprise a Web server. UI client 140 may comprise executable code (e.g., .exe, Java, Silverlight) executing within a browser or as a standalone application.

Application store frontend 124 provides any suitable functions for viewing, selecting and purchasing one or more business applications. Application store frontend 124 may access application store backend 130 to retrieve a catalog of business applications therefrom and/or to access ecommerce functionality (financial transaction execution, security, etc.).

Business configuration tools 126 may access business configuration 116 of tenant system 111 in order to determine a business application to present to UI client 140. The determination may be based on the data of business configuration 116 and on other rules and knowledge embodied in business configuration tools 126. For example, business configuration tools 126 may access or otherwise implement a knowledge base including configuration classifications, rules based on industry experience, business configurations of other existing tenant systems, usage patterns, and/or any other useful information.

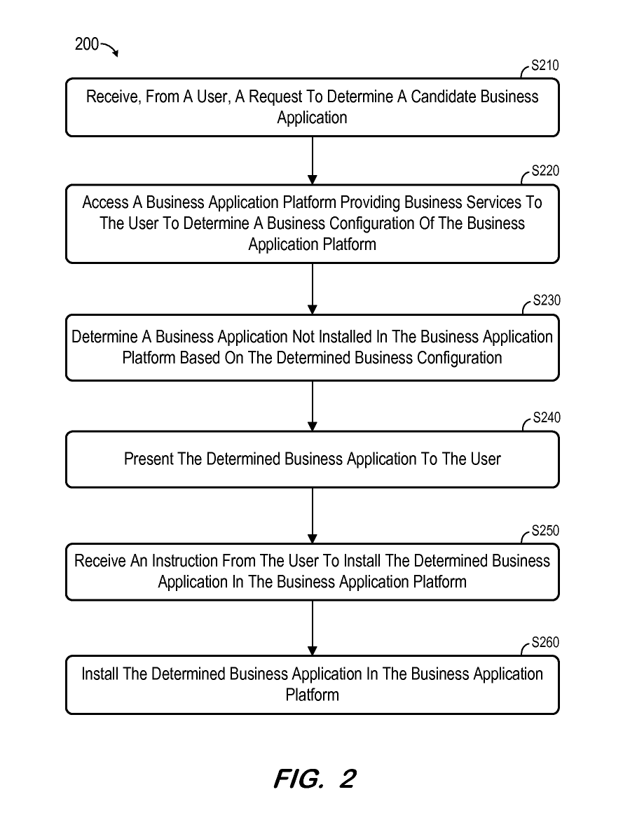

FIG. 2 is a flow diagram of a process 200 according to some embodiments. Business application platform 110 and/or application store 120 may execute portions of process 200 as will be described below, but embodiments are not limited thereto. In this regard, all processes described herein may be executed by any combination of hardware and/or software. The processes may be embodied in program code stored on a tangible medium and executable by a computing device to provide the functions described herein. The processes described herein do not imply a fixed order to their constituent steps, and embodiments may be practiced in any order that is practicable.

Initially, a request to determine a candidate business application is received from a user at S210. A candidate business application is a business application that may be installed in the business application platform of the user (e.g., business application platform 110). The request may include any number of filtering criteria provided by the user, such as industry, topic, function, cost, etc.

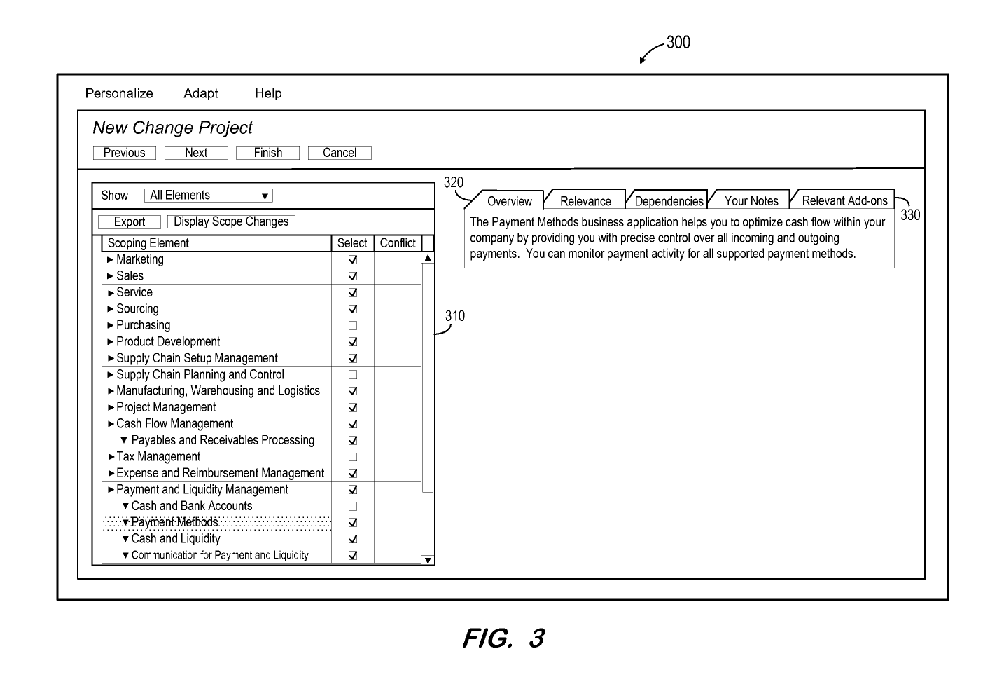

The request may be received at S210 in any number of operational scenarios according to some embodiments. In one example, the user views business configuration 116 through UI server runtime 113 of tenant system 11. FIG. 3 illustrates user interface 300 provided by UI server runtime 113 and presented by UI client 140 according to some embodiments. Pane 310 of user interface 300 shows currently-installed applications. Overview tab 320 provides a general description of a business application which is selected in pane 310.

Also shown is Relevant Add-ons tab 330. By selecting tab 330, the user transmits the request to determine a candidate business application that is received at S210. The request may comprise a request to determine a candidate business application that is specifically relevant to the business application which is selected in pane 310, or that is relevant to the overall business configuration of tenant system 111.

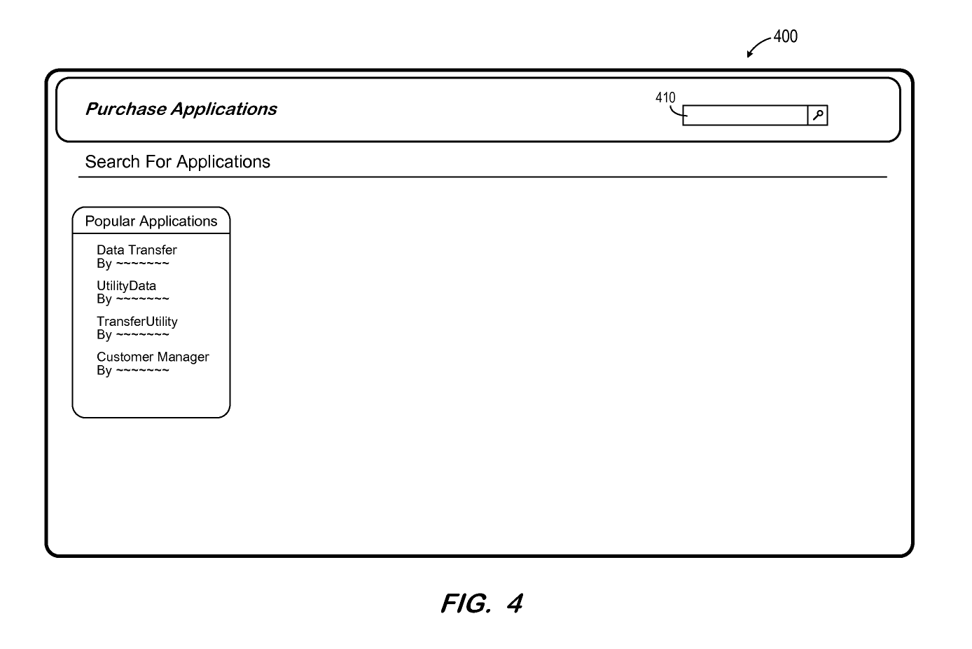

FIG. 4 illustrates interface 400 which may be provided to UI client 140 by UI server runtime 122 prior to S210 according to some embodiments. For example, a user may operate UI client 140 to access application store 120 (e.g., by inputting a Uniform Resource Locator (URL) corresponding to application store 120 into a Web browser). UI client 140 may then interact with application store frontend 124 to access interface 140, which allows UI client 140 to search for business applications, presumably to purchase and install those applications into business application platform 110. The entry and submission of search terms using input field 410 may also comprise a request to determine a candidate business application that is received at S210.

At S220, a business application providing business services to the user is accessed. The purpose of this access is to determine a business configuration of the business application platform. As mentioned above, a business configuration may include any types of data, including but not limited to size, location, industry, resource demands, budget, number of users, number of facilities, accounting standards, etc.

In one example of S220, business configuration tools 126 are invoked to communicate with business configuration 116 of tenant system 111. Assuming that business application platform 110 includes more than on tenant system, business configuration tools 126 communicates with business configuration 116 of the tenant system associated with the user. The business configuration of the business application platform may be determined based on information in addition to that (e.g., business configuration 116) stored in the corresponding tenant system.

Next, at S230 at least one business application which is not installed in the business application platform is determined based on the business configuration determined at S220. As also described above, the determination may be based on, in addition to the determined business configuration, other rules and knowledge embodied in and/or accessible by business configuration tools 126.

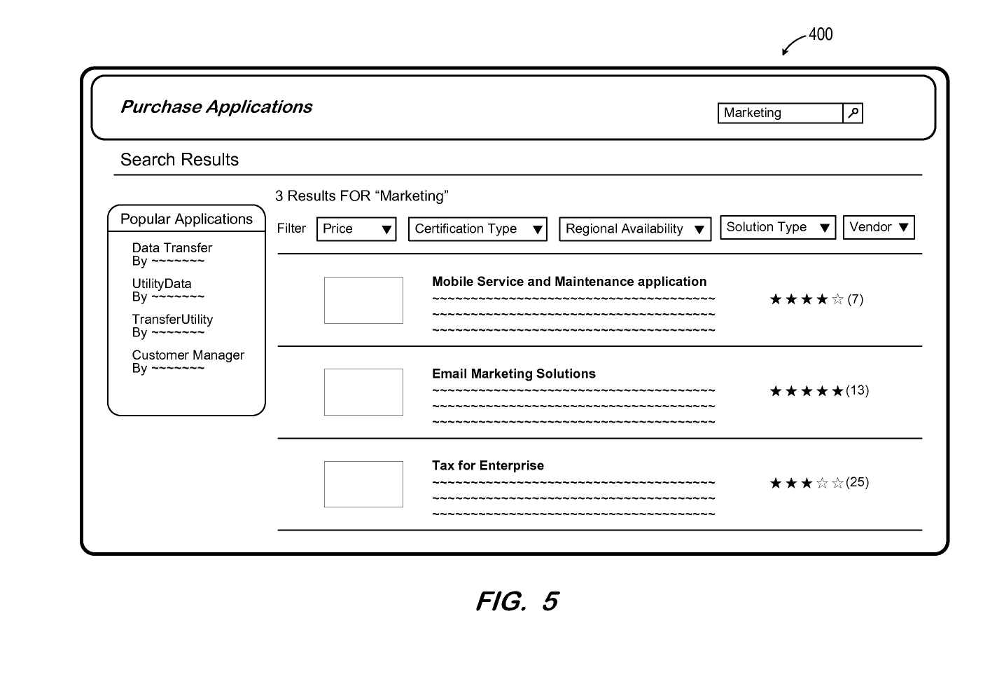

The determined business applications are presented to the user at S240. FIG. 5 illustrates user interface 400 after the user has searched for business applications using the term “marketing”. Accordingly, the determination at S230 may have included searching of application store backend 130 based on the search term “marketing, and also incorporated knowledge of business configuration 116 to filter the search results and/or to modify the search terms themselves.

S250 includes reception of an instruction from the user to install the determined business application in the business application platform. Continuing with the FIG. 5 example, the user may select any of the presented business applications in order to commence an ecommerce transaction with application store backend 130 to purchase the selected application.

After the purchase is complete, the determined business application is installed in the business application platform at S260. Systems for installing business applications into a business application platform are known. Contrary to known systems, however, process 200 advantageously facilitates determination and installation of suitable business applications into an existing business application platform by determining the business configuration of the business application platform directly therefrom.

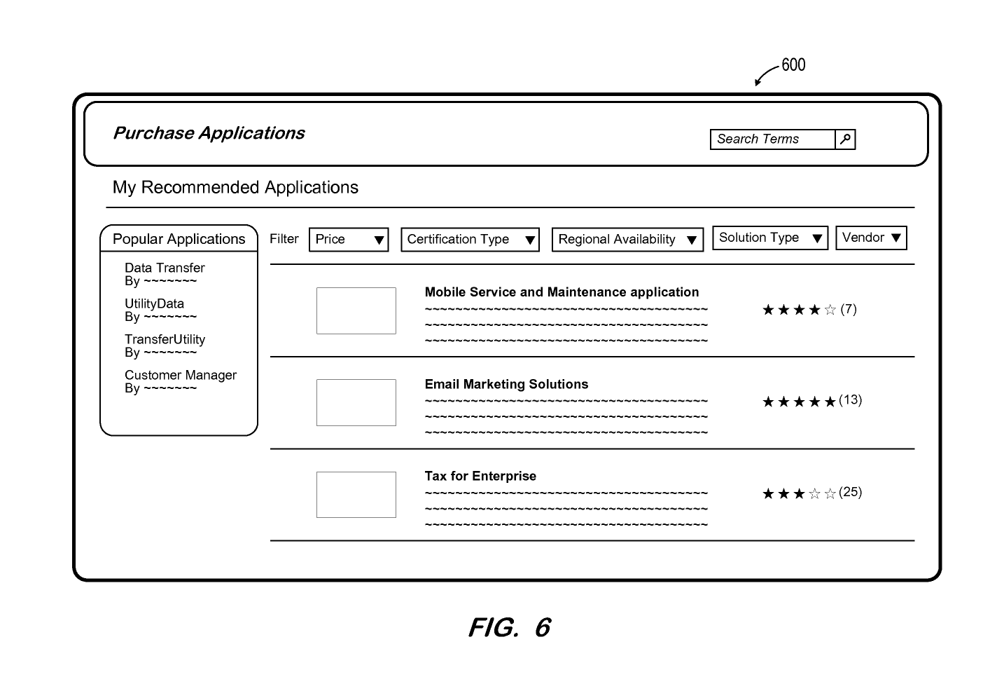

FIG. 6 illustrates interface 600 according to some embodiments. Interface 600 may be accessed and presented as described above with respect to interface 400. However, interface 600 displays “recommended” applications without requiring search terms from the user. Accordingly, a request for user interface 600 may be considered a request to determine a candidate business application which is received at S210. A business application may be selected, purchased and installed from user interface 600 as described above with respect to interface 400.

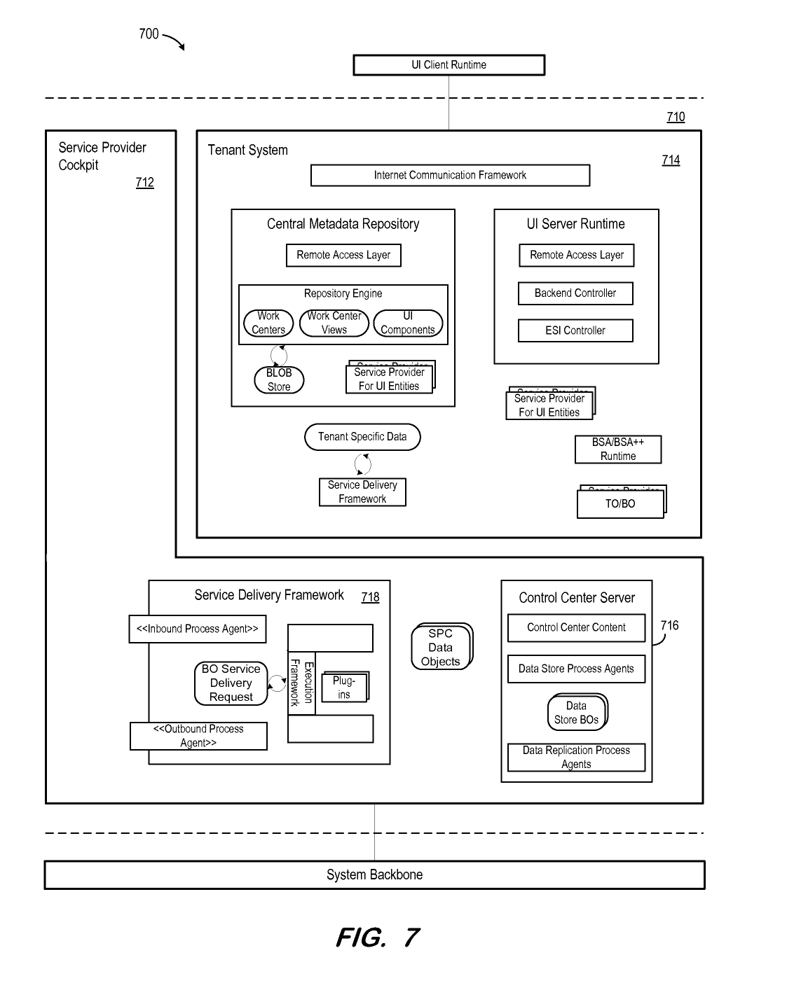

FIG. 7 is a detailed block diagram of architecture 700 according to some embodiments. Architecture 700 may comprise an implementation of the left side of system 100 of FIG. 1.

Service provider zone 710 hosts an on-demand system infrastructure, including one or more tenant systems, each associated with a customer. Service provider cockpit (SPC) 712 provides maintenance and coordination of the tenant systems by managing and running all tenant-related process and services.

Tenant system 714 is an on-demand system hosted by the provider of the business application platform. Tenant system 714 holds customer data and is scoped and configured up to the customer's demands. A customer may, as described above, connect to his dedicated tenant system via a Web browser. A single customer may be associated with multiple tenant systems, for example one for test and one for production.

Control center server 716 is a central component for consolidation of all process and status-related data that shall be retrievable via the customer, reseller or partner control center. Control center server 716 includes a data store storing consolidated data in process-specific business objects.

Service delivery framework 718 receives data from other systems. Service delivery framework 718 is extensible via plugins. For each process to be supported, a plugin may receive message-based data and insert it into the data store.

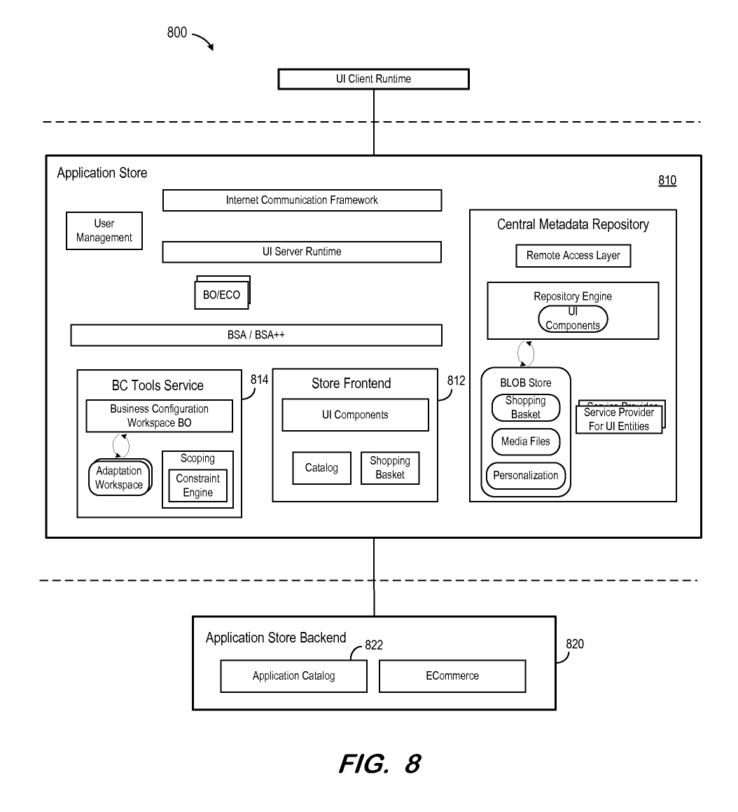

FIG. 8 is a detailed block diagram of architecture 800 according to some embodiments. Architecture 800 may comprise an implementation of the right side of system 100 of FIG. 1. Accordingly, embodiments of architectures 700 and 800 may operate to execute process 200 of FIG. 2.

Application store 810 provides a platform through which customers may purchase new business applications. Store frontend 812 hosts a catalog view on application catalog 822 of application store backend 820 and the product integrated view which takes the relation to the business configuration into account. Backend 820 may generally hosted components which require a higher security level.

Business configuration tools service 814 may communicate with components of tenant system 714 as described above to provide integration with application store 810 and determination of business applications based on a business configuration of tenant system 714. Business configuration tools service 814 and UI components of frontend 812 may thereafter operate to filter the full catalog of business applications based on the business configuration of tenant system 714 and to present the filtered catalog to a user.

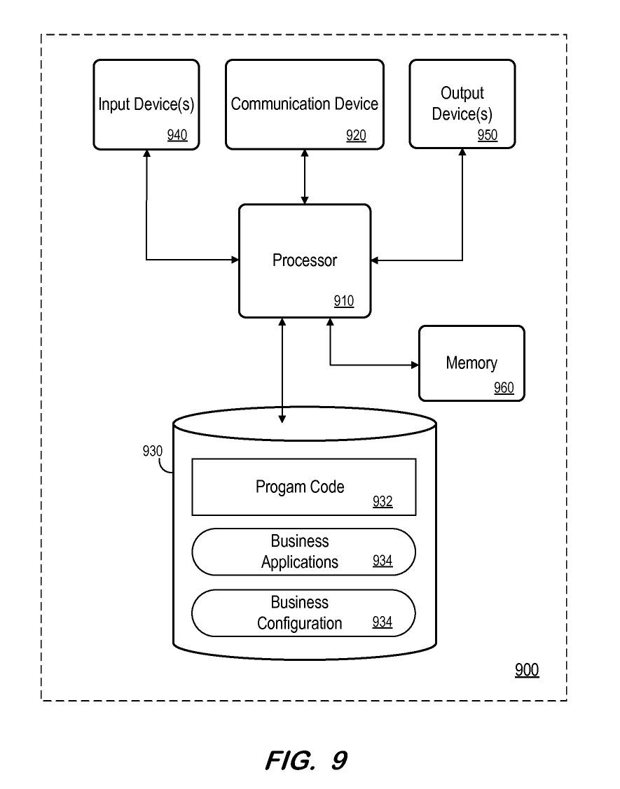

FIG. 9 is a block diagram of apparatus 900 according to some embodiments. Apparatus 900 may comprise a general-purpose computing apparatus and may execute program code to perform any of the functions described herein, including but not limited to process 200. Apparatus 900 may comprise an implementation of one or more elements of system 100, architecture 700 and/or architecture 800. Apparatus 900 may include other unshown elements according to some embodiments.

Apparatus 900 includes processor 910 operatively coupled to communication device 920, data storage device 930, one or more input devices 940, one or more output devices 950 and memory 960. Communication device 920 may facilitate communication with external devices, such as an external design tool. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to enter information into apparatus 900. Output device(s) 950 may comprise, for example, a display (e.g., a display screen) a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, etc., while memory 960 may comprise Random Access Memory (RAM).

Program code 932 of data storage device 930 may be executable by processor 910 to provide any of the functions described herein, including providing a business application platform and an application store. Embodiments are not limited to execution of these functions by a single apparatus. Business applications 934 may include any business applications as described herein, and business configuration 936 may comprise a business configuration of a business application platform. Data storage device 930 may also store data and other program code for providing additional functionality and/or which are necessary for operation thereof, such as device drivers, operating system files, etc.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, comprising:
receiving, from a user, a request to determine a candidate business application;
accessing a business application platform providing business services to the user in order to determine a business configuration of the business application platform; and
determining a first business application not installed in the business application platform based on the determined business configuration.

2. A method according to claim 1, further comprising:
presenting the determined business application to the user;
receiving an instruction from the user to install the determined business application in the business application platform; and
installing the determine business application in the business application platform.

3. A method according to claim 1, wherein receiving the request from the user comprises:
receiving a query to search a catalog of business application, and
wherein determining the first business application comprises executing the query based on the determined business configuration.

4. A method according to claim 1, wherein receiving the request from the user comprises:
receiving a request to view the business configuration of the business application platform.

5. A method according to claim 1, wherein determining the business application comprises:
evaluating predetermined rules with respect to the determined business configuration to identify a plurality of business applications including the business application.

6. A method according to claim 1, wherein the business application platform provides business services to the user as Web Services.

7. A non-transitory medium storing processor-executable program code, the program code executable by a device to:
receive, from a user, a request to determine a candidate business application;
access a business application platform providing business services to the user in order to determine a business configuration of the business application platform; and
determine a first business application not installed in the business application platform based on the determined business configuration.

8. A medium according to claim 7, the program code further executable by the device to:
present the determined business application to the user;
receive an instruction from the user to install the determined business application in the business application platform; and
install the determine business application in the business application platform.

9. A medium according to claim 7, wherein receipt of the request from the user comprises:
receipt of a query to search a catalog of business application, and
wherein determination of the first business application comprises execution of the query based on the determined business configuration.

10. A medium according to claim 7, wherein receipt of the request from the user comprises:
receipt of a request to view the business configuration of the business application platform.

11. A medium according to claim 7, wherein determination of the business application comprises:
evaluation of predetermined rules with respect to the determined business configuration to identify a plurality of business applications including the business application.

12. A medium according to claim 7, wherein the business application platform provides business services to the user as Web Services.

13. A system comprising:
a computing device comprising:
a memory system storing processor-executable program code; and
a processor to execute the processor-executable program code in order to cause the computing device to:
receive, from a user, a request to determine a candidate business application;
access a business application platform providing business services to the user in order to determine a business configuration of the business application platform; and
determine a first business application not installed in the business application platform based on the determined business configuration.

14. A system according to claim 13, the processor further to execute the processor-executable program code in order to cause the computing device to:
present the determined business application to the user;
receive an instruction from the user to install the determined business application in the business application platform; and
install the determine business application in the business application platform.

15. A system according to claim 13, wherein receipt of the request from the user comprises:
receipt of a query to search a catalog of business application, and
wherein determination of the first business application comprises execution of the query based on the determined business configuration.

16. A system according to claim 13, wherein receipt of the request from the user comprises:
receipt of a request to view the business configuration of the business application platform.

17. A system according to claim 13, wherein determination of the business application comprises:
evaluation of predetermined rules with respect to the determined business configuration to identify a plurality of business applications including the business application.

18. A system according to claim 13, wherein the business application platform provides business services to the user as Web Services.
